(19) United States
(12) Patent Application Publication
(10) Pub. No.: US 2004/0151129 A1
(43) Pub. Date: Aug. 5, 2004

(54) Controller for controlling routers

(76) Inventors: Gyula Kun-Szabo, Budapest (HU); Gergely Homanyi, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/430,675

(22) Filed: May 7, 2003

Related U.S. Application Data
(60) Provisional application No. 60/443,844, filed on Jan. 31, 2003.

(51) Int. Cl. H04L 12/28

(52) U.S. Cl. 370/254

(57) ABSTRACT

A controller for controlling a plurality of network nodes in a communications network is disclosed. The controller is arranged to define a group of network, nodes to be monitored based on a value of one or more attributes of said network nodes. The network nodes may be routers.

### CROSS REFERENCE TO RELATED APPLICATIONS

This application claims priority of U.S. Provisional Patent Application Serial No. 60/443,844, entitled “A Controller for Controlling Routers,” filed on Jan. 31, 2003, the contents of which are hereby incorporated by reference.

### BACKGROUND OF THE INVENTION

1. Field of the Invention

The present invention relates to a controller for controlling a plurality of network nodes such as routers in a network and to a method of controlling a plurality of network nodes in a network and in particular but not exclusively to a wireless network.

2. Description of the Related Art

A diverse range of communication systems are in use today enabling communication between two or more entities, such as user equipment and/or other nodes associated with the system.

In the last few years the Internet has seen a rapid growth so that the Internet has become one of the single most important tools for communication. Along with the growth of the Internet the need for quick and ready access to the Internet from any location has increased. Wireless broadband networks have been proposed which make high performance Internet access possible. In particular, new wireless networks with wireless routers as network nodes on a mesh network basis emulate the topology and protocols of the Internet but are optimized for wireless high-speed data transmission. To provide a wireless broadband solution a wireless routing network has been developed. The key components of such a wireless routing network are routed mesh network architecture, wireless routers, a wireless operating system and the deployment and management of the network.

Routed mesh networks mirror the structure of the wired Internet. Each radio transceiver at a node in the wireless network becomes part of the infrastructure and can route data through the wireless mesh network to its destination just as in the wired Internet. The advantage of such a routed mesh networks is that line-of-sight problems can be reduced in comparison to a client/base station architecture because each node only needs line-of-sight to one other node in the network and not all the way to the ultimate destination of the data traffic, e.g. the point-of-presence (POP). With such an infrastructure the reach and coverage of the wireless network is extended with a minimal amount of wireless network infrastructure and interconnection costs. The data traffic can be routed around obstructions rather than needing to deploy additional base stations for line-of-sight in densely populated diverse geographical locations. The more wireless routers are added to the network, the more robust and far-reaching the network becomes. In the above-mentioned wireless routing network, wireless routers with omni-directional antennas are used as a network node. Each wireless router can communicate with other nodes, i.e. other wireless routers in any direction. The omni-directional antennas offer a 360-degree range and do not require precise pointing or steering. Therefore additional wireless routers can be added in an ad hoc and incremental fashion.

The wireless routers substantially comprise three components, namely a full TCP/IP (Transmission Control Protocol/Internet Protocol) protocol suite support, a wireless operating system that optimizes the wireless network performance and robustness, and a high-performance digital RF modem. A specialized wireless networking software in combination with the high-performance RF modem optimizes the network performance while ensuring full IP support and robust and stream-less IP routing.

Routed wireless mesh networks deploy specialized protocols, that operate efficiently in a multi-hop wireless network environment. From the media access control (MAC) layer through to the routing layer protocols are used that are specifically designed to deal with their unique attributes. The protocol suite extends the traditional TCP/IP stack to provide efficient and robust IP-based networking in multi-hop wireless mesh networks. These protocols consist of four parts, namely channel access protocols, reliable link and neighbour management protocols, wireless multi-hop routing and multicast protocols, and standard Internet protocols.

In the channel access, protocols are used to efficiently schedule transmissions to avoid collisions and efficiently reuse the available spectrum. Reliable link and neighbor management protocols ensure reliable transmissions on a hop-by-hop basis, and manage the automatic adaptation to changes in the network topology by monitoring the status of neighbor links. The role of the reliable link and neighbor management protocols is to perform network synchronization and to manage the links to each neighbor node. Wireless multi-hop routing and multicast protocols maintain performance-optimized routing tables and enable an efficient multicast capability. The standard Internet protocols and tools are used for seamless integration with the wired Internet. The protocols and tools are for example TCP/IP, UDP (User Datagram Protocol), SNMP (Simple Network Management Protocol), RIP, ICMP (Internet Control Message Protocol), TFTP, ARP, IGMP, Proxy-ARP, DHCP relay (Dynamic Host Configuration Protocol), DHCP server, and NAT (Network Address Translation).

Wireless mesh networks based on a multipoint-to-multipoint architecture make an ad hoc integration of new nodes, i.e. wireless routers, easier since the actual demand and traffic flow in such a wireless network environment makes it much easier to adjust the coverage and bandwidth needs than design a network ahead of time. Adaptive routed mesh network make obstructions to the line-of-sight by growing trees or temporary obstructions less problematic, since the data traffic is automatically rerouted through as a link becomes unavailable. The nodes, i.e. wireless routers, in such a wireless routing network environment can adapt to changes in the link availability and the quality in real-time without requiring intervention by a network administrator.

Regardless of whether the communication network is a wired or wireless network, the network should be monitored continuously so that the operator can have an overview of the general status of the network and its, potentially problematic parts. In particular, if a network is not properly monitored, problems with loading of nodes can occur. Overloading can result in a poor service. Additionally, if a faulty node is not identified or the nature of its fault is not properly identified, this could have an adverse impact on the network. This is a particular problem with large networks, such as telecommunication networks, regardless of the standard used in those communication networks.

Defining and changing monitoring schemes of certain network nodes requires human intervention, which is time consuming and, as with all human operations, inherently error-prone. When there are a great number of nodes (for example routers) that need attention, it is easy to miss some of them or introduce errors because of mistyped user input.

In a known approach, fixed monitoring group assignment is used. If, for example, there are a great number of routers that need to be reconfigured in a batch to use a newer version of their operating system software, they have to be manually registered in a corresponding monitoring group that is aware of the different needs of the new software version. Further problems with this manual re-registration may occur if a different kind of polling is required.

If the operator wanted to avoid this manual assignation phase, the monitoring software had to be scriptable so that some external tool could generate the necessary updating script commands.

In another known approach, different monitoring groups have to be defined on different management computers (called for example Collection Stations in HP OpenView). On one given management station the polling timings, for example, are global. This is inflexible.

### SUMMARY OF THE INVENTION

It is an aim of embodiments of the present invention to address the problems discussed about.

According to one aspect of the invention, there is provided a controller for controlling a plurality of network nodes in a communications network, the controller being arranged to define a group of network nodes to be monitored based on a value of one or more attributes of the network nodes.

According to a second aspect of the invention, there is provided a communications system comprising a plurality of network nodes in a communications network, and a controller, the controller being arranged to define a group of network nodes to be monitored based on a value of one or more attributes of the network nodes.

According to a third aspect of the invention, there is provided a method for monitoring a plurality of network nodes in a communications network, the method comprising the step of defining a group of network nodes to be monitored based on one or more attributes of the network nodes

Embodiments of the present invention may be simple, cost-efficient, and robust and can handle large networks (e.g. thousands of routers or network elements).

### BRIEF DESCRIPTION OF THE DRAWINGS

For a better understanding of the present invention and as to how the same may be carried into effect, reference will now be made by way of example only to the accompanying drawings in which:

FIG. 1 shows a routing network with which embodiments of the present invention can be used;

FIG. 2, shows the entities to which the routing network of FIG. 1 is attached;

FIG. 3 shows schematically a flow diagram of embodiments of the present invention; and

FIG. 4 shows schematically the management engine of FIG. 2.

### DETAILED DESCRIPTION OF THE PREFERRED EMBODIMENT(S)

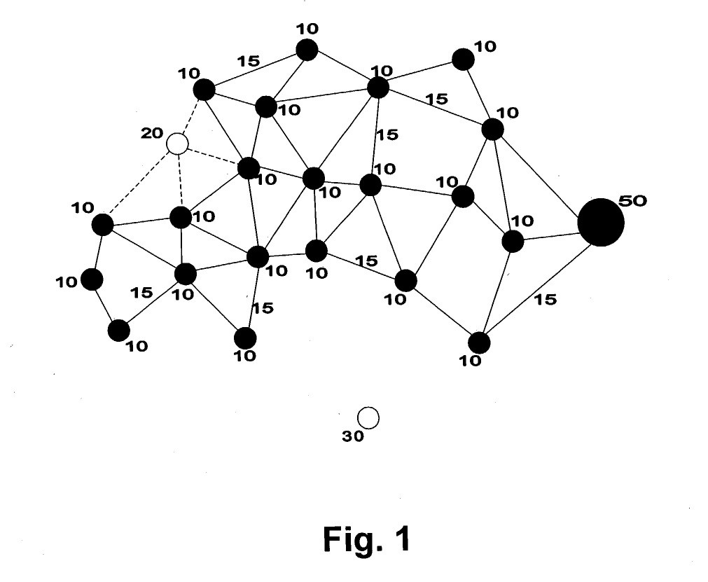

Embodiments of the present invention are particularly applicable to wireless communication networks or systems. FIG. 1 shows a schematic representation of the wireless network with a plurality of network nodes 10. Each network node 10 is connected to neighboring network nodes 10 via a multipoint-to-multipoint line-of-sight connection 15 by which the network nodes 10 communicate with each other. The wireless network comprise a Point-of-Presence POP 50 by which the wireless network is connected to the Internet or any other network. Into this wireless network with its existing network nodes 10 additional nodes 20, 30 are to be added.

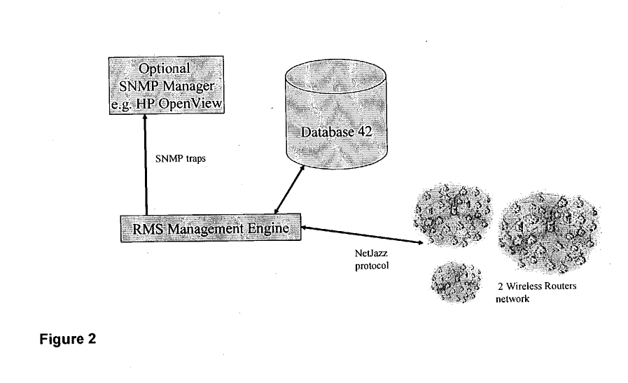

Reference is made to FIG. 2 which shows the network 2 connected to a RMS (router management system) management engine 9 via a connection in accordance with a NetJazz Protocol. The NetJazz protocol is a proprietary protocol developed by Nokia for use with their wireless mesh networks. The RMS engine 9 is arranged to monitor the network so that the operator can have an overview of the general status of the network and its potentially problematic parts. The RMS management engine is part of the management system for the wireless mesh network. It collects data from the wireless routers. It also translates alarms into SNMP traps that can be viewed with any umbrella management system that supports SNMP. With a single RMS management engine it is possible to continuously monitor large wireless router networks, generate alarms and collect performance data. Of course some embodiments of the invention may have more than one RMS management engine.

The RMS engine 9 may be optionally connected to a SNMP manager 40 such as HP (Hewlett Packard) OpenView products.

In the preferred embodiment the RMS engine is connected to a database 42 such as an ORACLE or MySQL database.

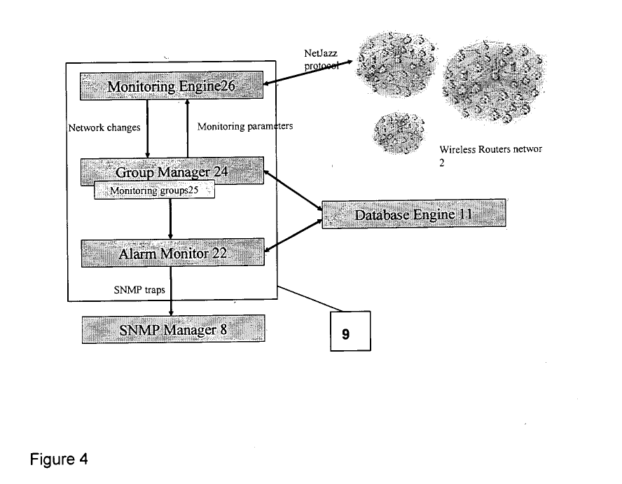

Reference is now made to FIG. 4 which shows the main modules of the RMS management engine 9. The RMS management engine 9 comprises an alarm monitor 22, a group manager 24 and a monitoring engine 26. The alarm monitor 22 is connected to the database engine 11 and it may be connected to an SNMP Manager system 8. The Group manager 24 is connected to the alarm monitor 22, the database engine 11 and the monitoring engine 26. In particular, the group manager 24 is arranged to send monitoring parameters to the monitoring engine 26 and to receive network monitoring data from the monitoring engine 26. The monitoring engine 26 is additionally arranged to be connected to the routing network 2. The monitoring engine 26 is responsible for monitoring network elements 10, implementing the actual monitoring protocol. The group manager 24 is responsible for maintaining the membership of monitoring groups 25 runtime depending on the received network element attributes. The alarm monitor 22 generates SNMP traps, this functionality depends on the actual monitoring groups 25 because the groups can have different alarm situations defined. The database engine 11 simply performs the database operations.

The RMS management engine 9 monitors the router network 2 by sending probes from the monitoring engine 26 to the network 2 and receiving reports from routers or network elements. The collected data is stored in the database 11. The RMS management engine examines the reports. It may apply e.g. fault detection criteria, leading to SNMP traps indicating detected faults as alarms. The list of collected alarms (traps) can be viewed through an SNMP manager 8 (after they have been relayed to the SNMP manager by the RMS management engine 9).

Monitoring parameters specify the performance and alarm monitoring frequency and data that is collected from the wireless router network. Node parameters relate to nodes e.g. routers in that particular network, while link parameters relate to connections between different nodes.

In the preferred embodiment routers have different ‘roles’ and their role can be configured on the fly by changing some operational parameters. These roles can be for example ‘mesh gateway’ and ‘subscriber router’. Additional roles can be defined by the users via the filter expressions determining the group membership, like “low traffic routers”, “experimental hardware version”, “potentially faulty routers”, etc. Any meaningful combination of status attribute value ranges can denote a particular “role”. The roles determine the needed frequency of probing by the RMS management engine 9 for each router.

In the responses to the probes from the RMS management engine 9, the routers report a subset of their operational attributes. The routers report to the RMS management engine 9. Depending on these values, a given router may need special attention and a different probing scheme may be required. A given router may be able to play two or more different roles either at the same time or at different time. The frequency of the probing, the alarm handling, and the required attributes may be changed. This will be described in more detail hereinafter.

The large number of routers in a network also requires an intelligent strategy for determining when a particular router should be probed to prevent network congestion and loss of status report data caused by big bursts of responses to probes. This can be achieved by the RMS management engine 9 applying different monitoring schemes to different parts of the network.

The RMS management engine is provided to deal with the fact that the statuses of the routers may change quickly. The RMS management engine is arranged to deal with a large number of routers in a network without the operator handling each network node one by one. Instead, the RMS management node 9 is arranged to apply general rules defined by the operator. These rules can be applied to a set of nodes at a time. Filtering rules are evaluated dynamically to determine if a given entity belongs to a monitoring group.

The RMS management engine 9 is arranged to change its monitoring behavior depending on the values of router status attributes and a set of strategy definitions that consist of Boolean filter expressions on the domain of the status attributes evaluated during monitoring of every router. In preferred embodiments of the present invention, the RMS management engine is arranged to control the following aspects of monitoring:

1. Supervised and logged status attributes of the wireless routers, for example, traffic flowing through the router, uptime, software/hardware version;

2. Timing parameters of the polling of the routers; and

3. Threshold values for alarm generation based on the status of the routers.

For example, such threshold values could be 1) there are at least X routers in the network that have not responded in the last Y minutes; 2) a Mesh Gateway has not responded within the last X minutes; or 3) a router has more than X neighbors. The RMS management engine can be tuned by editing a configuration file.

This file contains, among other settings, the group definitions (name, filtering expressions and ‘the overridden monitoring parameters mentioned above) used by the management engine.

When the application starts, it reads the definitions and sets up the monitoring groups. Then, before each polling cycle, it evaluates the group filters for each router, determines the group to which the router belong based on the filtering results and polls the elements of those groups that are eligible for polling at the given time.

In embodiments of the invention, rules are defined that are evaluated dynamically to determine if a given entity belongs to a supervision group. This contrasts which previously proposed solutions which statically assign group attributes to the entities.

Embodiments of the present invention allow the operator to define a new monitoring group e.g. based on the value of the status attribute containing the operating system (OS) version of the nodes. From that point on, whenever a node's OS is upgraded, the filter of the newly defined group automatically recognizes it and the device is handled according to the operating rules given in the group definition.

In one embodiment of the present invention, the network can be logically partitioned into e.g. ‘important’ and ‘ordinary’ nodes. The ‘important’ nodes then can be polled much more frequently, with requests for more detailed status reports while the ‘ordinary’ ones are allowed to report only basic data with a lower frequency. This can significantly reduce the management-related traffic on the network.

Embodiments of the present invention can for example collect automatically more data from faulty nodes than nodes which are running without problems. Embodiments of the invention may save network and management engine resources. The RMS management engine adjusts automatically to changes.

With the RMS management engine routers and their roles can be configured on the fly by changing their parameters. These roles are used for example to determine a needed frequency of probing. In responses to the probes, the routers report a subset of their operational attributes. Depending on these values, they might need special attention and a different probing scheme (e.g. frequency, alarm handling, required attributes). To prevent network congestion due to probing large number of routers in the network, an intelligent strategy is used. This is achieved by applying different monitoring schemes to different parts of the network. The RMS management engine thus changes its monitoring behavior depending on the values of router status attributes and a set of strategy definitions.

Embodiments of the invention have the advantage that there is dynamic behavior in the monitoring logic in the RMS management engine. It introduces some intelligence to the system, so that it becomes adaptive to a constantly changing network environment. For example: in one embodiment, the RMS management engine can poll those clusters of the network more frequently (e.g. every 5 minutes) where the routers were reset more than 10 times during the last week. The target group may change all the time.

There is no need for data exchange between the management software and any external tools to achieve this result.

In summary, embodiments of the present invention may result in no need for external data exchange interfaces to any kind of helper applications. Embodiments of the invention may result in no need for: scripting facilities; distributed hardware and software elements; and/or regular user intervention related to massive status changes.

Each router is arranged to handle group filter expressions.

The operational description is as follows:

The user edits the configuration of the RMS management engine. This is done by editing an XML file with a text editor. XML—eXtensible Markup Language—is a widely used standard to exchange structured data in textual format. Alternatively, any XML editor can be used as the DTD (Document Type Definition—a descriptor file that defines valid XML tags in a certain XML file) of the configuration file is shipped with the product.

The configuration settings for polling, status logging and alarm handling are defined in their corresponding XML tags and their attributes.

The group definitions are given in <group> elements. Their name, filtering expressions and the redefinitions of polling, status logging and alarm handling parameters have to be specified. The mentioned parameters have to be defined on the general ‘top level’, and they can have different values in each management group.

If a certain parameter is not redefined in a group, the value is inherited from the default configuration.

XML documents are used to define structured data and is well known to the man skilled in the art. An XML document contains elements which hold actual data. Each element has some attributes with their values, and can have also sub-elements (elements). The element names are written between ‘<’ and >’ characters. When an element has attributes the closing γ has to be typed after the attribute list. The elements must be closed with a special ending: “</elementname>” where “elementname” is the name of the element.

### EXAMPLE

```
    <myelement myattrib1=“myvalue1” myattrib2=“myvalue2”>
<mysubelement mysubelemAttrib=“5”/>
    </myelement>
```

In this example <mysubelement> should be closed by a </mysubelement>. Instead, because it has no sub elements, the end of the element can be signed by the “/” before the closing ‘>’.

The filtering expressions can use the following XML tags, as indicated in Tables 1 and 2 below:

TABLE 1

| | |
|---|---|
| <all> | Generalized Boolean ‘AND’ operator. Its value is true if and only if all of its sub- |
| | elements’ value is true, otherwise it is false. |
| | Example: |
| | <all> |
| | <equal value=“0”> |
| | <netjazz_attribute type=“node” id=“0x8f04”> the node id is |
| | the identity of the router |
| | </equal> |
| | <less_than_or_equal value=“10”> |
| | <netjazz_attribute type=“node” id=“0x0601”> |
| | </less_than_or_equal > |
| | <equal value=“1”> |
| | <netjazz_attribute type=“node” id=“0x1101”> |
| | </equal> |
| | </all> |
| | This evaluates to true for routers that are [not playing the mesh gateway |
| | role] AND [their reset count does not exceed 10] AND [they are 1 hop |
| | away from their mesh gateway]. This will now be explained - Group |
| | definition in XML file: |
| | The membership of a router can be described as a sentence in Boolean |
| | logic. Say every router is a member whose attribute 0x8f04 (this is a |
| | hexadecimal number) equals zero AND attribute 0x0601 is less than or |
| | equal to 10 AND attribute 0x1101 is equal to 1. (Note: Term ‘attribute’ |
| | here refers to a NetJazz protocol (NJP) attribute as the used hexadecimal |
| | constants are from NJP. Embodiments of the invention would work with |
| | any implementation where the attributes in question can be addressed with |
| | symbolic identifiers). |
| | This sentence contains 3 sub-conditions connected with “AND”, so on the |
| | upper level the <all> element is used. This means that the examined router |
| | is a member only if_all_the three sub-conditions are satisfied. |
| | The first sub-condition is that the router's attribute number 0x8f04 equals |
| | to 0. This is coded with the <equal> element: |
| | <equal value=“0”> |
| | <netjazz_attribute type=“node” id=“0x8f04”/> |
| | </equal> |
| <all> | The second condition is that the router's attribute number 0x0601 is less |
| | than or equal to 10. See the coded version: |
| | <less_than_or_equal value=“10”> |
| | <netjazz_attribute type=“node” id=“0x0601”/> |
| | </less_than_or_equal> |
| | etc. |
| | The three sub-condition can be wrapped in only one condition using the |
| | <all> element (with the meaning of Boolean *and*): |
| | <all> |
| | <equal value=“0”> |
| | ... |
| | </equal> |
| | <less_than_or_equal value=“10”> |
| | ... |
| | </less_...> |
| | <equal ...> |
| | ... |
| | </equal> |
| | </all> |
| <any> | Generalized Boolean ‘OR’ operator. Its value is true if at least one of its sub- |
| | elements' values is true, otherwise it is false. |
| | Example: |
| | <any> |
| | <equal value=“0”> |
| | <netjazz_attribute type=“node” id=“0x8f04”> |
| | </equal> |
| | <less_than_or_equal value=“10”> |
| | <netjazz_attribute type=“node” id=“0x0601”> |
| | </equal> |
| | <equal value=“1”> |
| | <netjazz_attribute type=“node” id=“0x1101”> |
| | </equal> |
| | </any> |
| | This evaluates to true for routers that are [not playing the Mesh Gateway |
| | role] OR [their reset count does not exceed 10] OR [they are 1 hop away |
| | from their gateway] |
| <not> | Boolean ‘NOT’ operator. Its value is true if and only if its sub-element's |
| | value is false. In some cases a negative definition can be used (e.g. the |
| | members are routers whose attribute 0x1101 is NOT equal to 1). So the |
| | members can report either 0 or 8 or 13 or anything but 1 as value of |
| | attribute 0x1101. This can be coded like: |
| | <not> |
| | <equal value=“1”> |
| | <netjazz_attribute type=“node” id=“0x1101”/> |
| | </equal> |
| | </not> |
| <true> | Boolean constant. Its value is always true. In the average case <true> and |
| | <false> tags may not be used, they are here for |
| | To make the logical expression system complete. |
| | To give a certain shortcut while testing different filtering expressions. For |
| | example, a complicated <all> element that is not needed in a given test run |
| | can be short-circuited by inserting a <false> tag as one of its sub- |
| | expressions. It will cause the expression all (false, exp1, exp2, ..., expN) to |
| | always fail, effectively ‘commenting out’ that part of the filter without the need to |
| | physically remove the expression. |
| <false> | Boolean constant. Its value is always false. |

TABLE 2

| | |
|---|---|
| <equal> | quality comparison. |
| | Example: |
| | <equal value=“0”> |
| | <netjazz_attribute type=“node” id= |
| | “0x8f04”> |
| | </equal> |
| | This evaluates to true if and only if a router's |
| | attribute designated by id 0x8f04 (gateway |
| | role) is 0. Read as ‘return true if NetJ azz |
| | node attribute 0x8f04 equals to zero, |
| | otherwise return false’. These expression |
| | definitions are read by the management |
| | engine from the configuration file and |
| | converted to normal logical predicates |
| | internally. |
| <less_than> | Less-than comparison. Syntax: see <equal>. |
| less_than_or_equal> | Shorthand for |
| | <any> |
| | <equal...> |
| | </equal> |
| | <less_than...> |
| | </less_than> |
| | </any> |
| <greater_than> | Greater-than comparison. Syntax: |
| | see <equal> |
| <greater_than_or_equal> | Shorthand for |
| | <any> |
| | <equal...> |
| | </equal> |
| | <greater_than...> |
| | </greater_than> |
| | </any> |

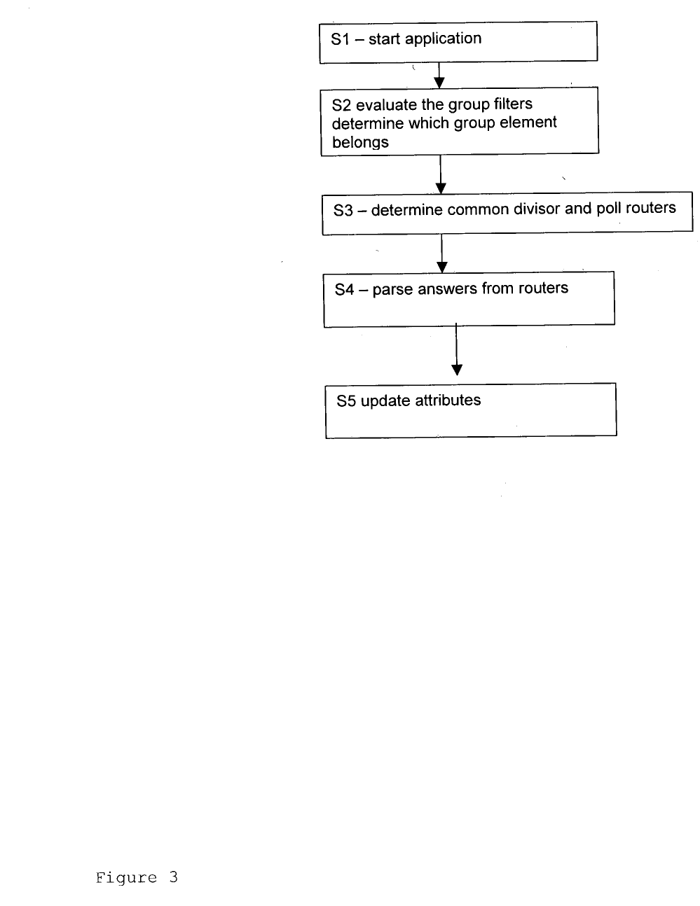

Reference is made to FIG. 3, which illustrates a method embodying the invention. In the first step Si, the application is started. After starting the RMS management engine, it parses in step S2 its configuration file and sets up the monitoring groups according to their—XML definitions. The criteria of group membership are defined by the user by describing the filter expressions of the groups using the XML tags discussed above in the configuration file of the management engine. In one implementation, the attributes are the wireless mesh routers' attributes. Other implementations can use their relevant status descriptors. The emphasis is not on the mode of describing the expressions but on the fact that these expressions are repeatedly evaluated during run-time of the management engine and the routers are enrolled in/removed from their respective groups based on the result of these filtering expressions.

The corresponding monitoring, attribute logging and alarm handling parameters are stored with the groups.

The monitoring parameters define the frequency for polling a given router or the like. Examples of this are frequency of polling, frequency of calculating the set of routers that would be polled in next polling cycle or link timeout threshold.

The groups, may redefine not only the monitoring parameters but the logging details and the alarm handling as well.

The attribute parameters define those parameters which should be reported back to the RMS management engine and can include NetJazz attributes that can be reported by the routers or in alternative embodiments of the invention any relevant attribute that can be reported. The alarm handling parameters define how the router should be dealt with in the event that the router has an alarm condition. The groups can redefine the alarm conditions. For example in general a certain node is allowed to carry a given amount of traffic for say 10 minutes before being reported. This can be redefined so that this is redefined for mesh gateways to 20 minutes as gateways carry more traffic than ordinary routers.

In step S3, management engine examines all groups' polling-related parameters and computes their greatest common divisor. For example if one group has a polling time of 10 minutes, another group has a polling time of 60 minutes and the third group have a polling time of 100 minutes, the greatest common time is 10 minutes. This common value will be used as, the polling clock's time tick. Whenever a tick happens the groups whose polling time has arrived collect their nodes by evaluating the group filters against the routers' attributes and poll the routers. Thus, every time a tick arrives, the first group is polled with the second group being polled every 6 ticks and the third group being polled every 10 ticks. After having probed the routers, the engine sleeps until the next tick arrives.

It should be appreciated that the above polling times are by way of example only and in practice can be longer or shorter than those. The polling frequency is a function of the network size. The larger the network, the smaller the frequency should be to avoid overloading the management engine. These times can be different in each group.

At this point, that is when the next tick arrives, the polling cycle starts again.

As answers come from the polled routers, they are parsed in step S4 and the corresponding router's attributes are updated in step S5.

After this step, the alarm-monitoring phase examines the routers' state and acts as necessary in step S6. The different groups can have different alarm threshold settings, which allow a fine-tuned setup for alarm supervision.

An alternative form of implementation could use separate threads for each monitoring group with their own polling timer instead of having one running with the greatest common denominator of the specified polling intervals. This would allow handling more routers at a cost of increased complexity of the software due to the necessary locking to control inter-thread data flow.

The preferred embodiments of the invention have been described in the context of a Nokia wireless mesh system using NetJazz protocol. It should be appreciated that firstly, embodiments of the invention can be used with any other protocol. Secondly, the invention can be implemented in any network regardless of its type where there is a plurality of routers or network elements. The network can be any type of communications network and the network can be wired, wireless or a combination thereof.

In alternative embodiments of the invention, other elements maybe alternatively or additionally monitored instead of or as well as routers.

Embodiments of the invention can be generalized to any situations where a large number of entities have to be supervised and their handling has to be different based on the results of polling as long as their status attributes can be addressed by symbolic identities.

Embodiments of the present invention have been described in the context of a wireless communications network. However it should be appreciated that embodiments of the present invention can be used in any other network or system having a number of routers or elements requiring managements. For example embodiments of the present invention can be used in a wired system.

In preferred embodiments of the present invention, each network may have its own RMS management engine. However in some embodiments of the invention, a network may have more than one RMS management engine. The RMS management engines may operate independently or may be in communication. In some embodiments of the present invention, a single RMS management engine may serve more than one network.

In preferred embodiments of the invention, the RNS management engine is provided by a single entity. In alternative embodiments of the present invention, the functionality of the RMS management engine may be provided in a distributed manner.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A controller for controlling a plurality of network nodes in a communications network, said controller being arranged to define a group of network nodes to be monitored based on a value of one or more attributes of said network nodes.

2. A controller as claimed in claim 1, wherein a plurality of groups of network nodes to be monitored are provided, at least two of said groups having at least one different value of one, or more attributes.

3. A controller as claimed in claim 1, wherein said network nodes are routers and said communications network is a routing network.

4. A controller as claimed in claim 3, wherein said routers are wireless routers and said communications network is a wireless routing network.

5. A controller as claimed in claim 1, wherein the value of the one or more attributes is used to define a group based on:
software versions used by said network nodes;
functions of said network nodes;
amounts of traffic through said network nodes;
potentially faults in the network nodes; and
experimental natures of network nodes.

6. A controller as claimed in claim 1, wherein said controller is arranged to apply different monitoring schemes to different parts of said network.

7. A controller as claimed in claim 1, wherein said controller is arranged to apply different monitoring schemes to different groups of network nodes.

8. A controller as claimed in claim 1, wherein at least two groups of network nodes are provided, with one group of network nodes providing a first function and another group of network nodes providing a second diifferent function.

9. A controller as claimed in claim 8, wherein said first function comprises a gateway function.

10. A controller as claimed in claim 8, wherein said second function comprises a subscriber router function.

11. A controller as claimed in claim 1, wherein said controller is arranged to collect performance data from said communication network.

12. A controller as claimed in claim 1, wherein said controller is arranged to define at least one of:
performance parameters of said network nodes to be monitored;
an alarm monitoring frequency; and
data to be collected from said network nodes.

13. A controller as claimed in claim 1, wherein said controller is arranged to generate alarms.

14. A controller as claimed in claim 12, wherein said controller is arranged to translate alarms into traps.

15. A controller as claimed in claim 14, wherein said traps comprise SNMP traps.

16. A controller as claimed in claim 14, wherein said controller is connected to a management system which views said traps.

17. A controller as claimed in claim 1, wherein said controller is arranged to send probes to said network nodes.

18. A controller as claimed in claim 1, wherein said controller is arranged to receive data from said network nodes in response to said probes.

19. A controller as claimed in claim 1, wherein said controller is connected to a database which stores network node data.

20. A controller as claimed in claim 1, wherein the controller is arranged to control timing parameters relating to the polling of the network nodes.

21. A controller as claimed in claim 1, wherein said controller is arranged to control threshold values for alarm generation based on the status of the network nodes.

22. A controller as claimed in claim 1, wherein said controller is arranged to carry out a plurality of polling cycles with respect to said network nodes.

23. A controller as claimed in claim 22, wherein before each polling cycle of the plurality of polling cycles, the controller is arranged to determine which network node of said plurality of network nodes belongs to which group and to poll the network nodes of at least one group eligible for polling in a respective polling cycle.

24. A controller as claimed in claim 23, where each network node has associated therewith at least one attribute, said controller determining to which at least one group said network node belongs based on the value of said at least one attribute.

25. A controller for controlling a plurality of routers in a communications network, said controller being arranged to monitor the plurality of routers, wherein monitoring behavior of said controller is determined by a value of one or more attributes of said routers.

26. A communications system comprising a plurality of network nodes in a communications network, and a controller, said controller being arranged to define a group of network nodes to be monitored based on a value of one or more attributes of said network nodes.

27. A system as claimed in claim 26, further comprising a database for storing monitored parameters of said nodes.

28. A method for monitoring a plurality of network nodes in a communications network, said method comprising the step of:
defining a group of network nodes to be monitored based on one or more attributes of said network nodes.

29. A method as claimed in claim 28, further comprising the step of:
carrying out a plurality of polling cycles with respect to said network nodes.

30. A method as claimed in claim 29, further comprising the step:
determining which group or groups of network nodes are to be polled in a given polling cycle.

31. A method as claimed in claim 29, further comprising the step of:
determining before each polling cycle which network nodes belong to a group to be polled in the respective polling cycle.

32. A method as claimed in claim 29, comprising the step of:
changing a value of at least one attribute of at least one network node to thereby change one or more groups to which said network node belongs.

33. A method as claimed in claim 29, wherein a network node of said plurality of network nodes is able to belong to a plurality of groups.

34. A monitor for monitoring a plurality of network nodes in a communications network, comprising:
defining means for defining a group of network nodes to be monitored based on one or more attributes of said network nodes.

35. A monitor as claimed in claim 34, further comprising:
polling means for carrying out a plurality of polling cycles with respect to said network nodes.

36. A monitor as claimed in claim 35, further comprising:
determining means for determining which group or groups of network nodes are to be polled in a given polling cycle.

37. A monitor as claimed in claim 35, further comprising the step of:
determining means for determining before each polling cycle which network nodes belong to a group to be polled in the respective polling cycle.

38. A monitor as claimed in claim 35, comprising the step of:
changing means for changing a value of at least one attribute of at least one network node to thereby change one or more groups to which said network node belongs.

39. A monitor as claimed in claim 35, wherein a network node of said plurality of network nodes is able to belong to a plurality of groups.
